(19) United States
(12) Patent Application Publication
(10) Pub. No.: US 2019/0087518 A1
(43) Pub. Date: Mar. 21, 2019

(54) FATIGUE LIFE PREDICTION METHOD AND DEVICE OF CONCRETE BASED ON WEIBULL FUNCTION AND RESIDUAL DEFORMATION

(71) Applicant: ZHEJIANG UNIVERSITY, Zhejiang (CN)

(72) Inventors: Botao HUANG, Zhejiang (CN); Qinghua LI, Zhejiang (CN); Shilang XU, Zhejiang (CN)

(21) Appl. No.: 15/871,293

(22) Filed: Jan. 15, 2018

(30) Foreign Application Priority Data
Sep. 19, 2017 (CN) 201710844645.7

(51) Int. Cl. G06F 17/50; G06F 17/11

(52) U.S. Cl. CPC G06F 17/5009; G06F 2217/16; G06F 17/11

(57) ABSTRACT

The present invention discloses a fatigue life prediction method and device of concrete based on Weibull function and residual deformation. With the continuous development of modern civil engineering, the fatigue performance of concrete materials has become one of the focuses of concern. The accurate prediction of fatigue life of concrete has become an important issue in the field of engineering construction. The method and device provided in the invention can be used to predict the life of concrete and fatigue deformation evolution law of concrete under the fatigue loads, having the advantages of concise steps, simpleness to use and high accuracy, etc. During the use, it can greatly reduce the computations, and only two fatigue parameters of the number of fatigue load cycles n and the residual deformation εₚ of the n^{th} cycle need to be measured, which simplifies the monitoring equipment. The model can provide an important technical support for engineering design, construction, monitoring and maintenance.

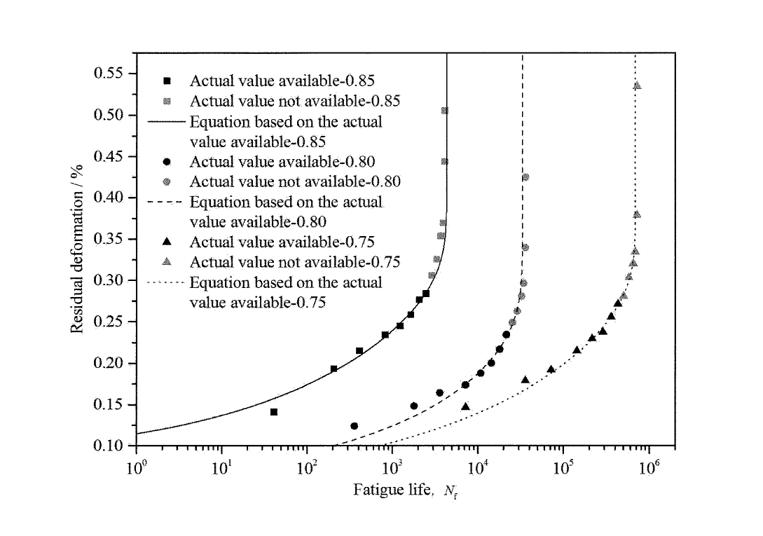

### FIELD OF THE INVENTION

The present invention relates to a fatigue life prediction technology of concrete.

### BACKGROUND

Since the advent of Portland cement in the 19^{th} century, concrete has been widely used in such fields as transportation, construction, water conservancy and marine engineering. It is the material used most widely in the engineering construction. In the early 20^{th} century, with the construction of reinforced concrete bridges, the related researches on the fatigue performance of concrete materials are gradually carried out. Since the 21^{st} century, with the construction of large-scale infrastructures such as highways, high-speed railways, super high-rise buildings, special high dams, cross-sea bridges and offshore platforms, concrete structures are faced with more complicated and harsh service conditions such as cyclic loads and alternating environments, etc. In addition, with the further development of the theory of concrete structure design and the popularization and application of high-strength concrete, the stress level of concrete is gradually increased during the service of the structure, which makes fatigue failure of concrete more likely. Therefore, in the continuous development of modern civil engineering, the fatigue performance of concrete materials has become one of the focuses of concern. How to accurately predict the fatigue life of concrete becomes an important issue in engineering design, construction, monitoring and maintenance. The existing characterization of fatigue performance and fatigue life prediction of concrete materials are mainly based on the evolution of materials' fatigue damage. Researchers have developed a series of fatigue models that establish the relationship of fatigue damage primarily through the attenuation of materials' elastic modulus and based on which, establish complex fatigue performance characterization and life prediction models. Existing models usually need to include many parameters such as fatigue strain, fatigue stress, elastic modulus and materials' fitting parameters. The model is complicated and generally needs to be iteratively calculated. Thus, it is difficult to popularize and apply it in engineering construction. Therefore, it is very urgent to propose a fatigue life prediction method and device of concrete with concise steps, simpleness to use and high precision, which can provide important technical support for engineering design, construction, monitoring and maintenance.

### SUMMARY

An object of this invention is to provide a fatigue life prediction method of concrete with concise steps, simpleness to use and high precision. To this end, the present invention employs the following technical solutions.

A fatigue life prediction method of concrete based on Weibull function and residual deformation, comprising the following steps:

(1) acquire several (i) residual deformation εₚ and the number of fatigue load cycles n corresponding to each deformation of the concrete under a fatigue load at one certain stress level, i.e. (εₚ₁, n₁), (εₚ₂, n₂), (εₚ₃, n₃), . . . , (εₚᵢ, nᵢ); the residual deformation εₚ refers to the deformation corresponding to the stress at zero;

(2) substitute the several (i) residual deformation and the corresponding fatigue life cycle into the following equation for fitting and solving, to obtain parameters of the equation:

n=N_{f}(1−exp(−((εₚ−εₚ₀)/λₚ)^{k}^{ₚ}))

wherein, N_{f} is fatigue life, εₚ₀ is position parameter, λₚ is scale parameter, kₚ is shape parameter;

The parameter N_{f} obtained in step (2) is the prediction of fatigue life, and the resulting equation is used to characterize the evolution law of fatigue deformation.

Further, an optional value for position parameter εₚ₀ is zero, and another optional value is the residual deformation of the concrete after the first cycle of the fatigue load.

Further, λₚ/kₚ is set to the same value for the same kind of concrete material. Further, the same value can be the strain rate of the second stage in the fatigue deformation versus normalized fatigue life curve of the concrete material, i.e. ∂ε/∂(n/N_{f}), so as to simplify the fitting process and improve the accuracy of the prediction results.

Another object of the invention is to provide a fatigue life prediction device of concrete based on Weibull function and residual deformation, to this end, the present invention employs the following technical solutions:

A fatigue life prediction device of concrete based on Weibull function and residual deformation, comprising a data acquisition module, a parameter determination module and an information transmission module;

The data acquisition module is used to acquire several residual deformation εₚ and the number of fatigue load cycles n corresponding to each deformation of the concrete under a fatigue load at one certain stress level; the residual deformation εₚ refers to the deformation corresponding to the stress at zero;

The parameter determination module is used to substitute the several residual deformations and the corresponding fatigue life cycle into the following equation for fitting and solving, to obtain parameters of the equation:

n=N_{f}(1−exp(−((εₚ−εₚ₀)/λₚ)^{k}^{ₚ}))
wherein, N_{f} is fatigue life, εₚ₀ is position parameter, λₚ is scale parameter, kₚ is shape parameter;

The information transmission module is used to transmit parameters of the equation obtained by fitting and solving to a fixed receiver or a mobile receiver, wherein the parameter includes N_{f}.

The invention provides a fatigue life prediction method and device of concrete based on Weibull function and residual deformation. Using the method and device, as long as acquiring several residual deformation εₚ and the number of fatigue load cycles n corresponding to each deformations, and substituting them into the equation for fitting and solving, the fatigue life and deformation evolution law can be obtained, having the advantages of concise steps, simpleness to use and high accuracy, etc. In the process of using, it can greatly reduce the calculation, and only need to measure two fatigue parameters of the number of fatigue load cycles n and the residual deformation εₚ of the n^{th} cycle, which can simplify the monitoring equipment. The model can provide important technical support for engineering design, construction, monitoring and maintenance.

### BRIEF DESCRIPTION OF THE DRAWINGS

The sole FIGURE is a graph of actual measured results and predicted results of the residual deformation and fatigue life of fiber-reinforced concrete under the fatigue load according to Example 1 of the present invention.

### DETAILED DESCRIPTION

The present invention is further described in combination with drawings and specific embodiments. The embodiments are intended to illustrate the present invention, but not to limit the invention in any way.

This example predicts the compression fatigue life and characterizes the evolution law of fatigue deformation of three fiber concrete samples with the stress levels of 0.85, 0.80, and 0.75 respectively.

For the same concrete material, λₚ/kₚ can be set to the same value. Therefore, in this example, a compressive fatigue test on three samples of the same type of fiber-reinforced concrete at a stress level of 0.90 is performed firstly, to obtain the average value of λₚ/kₚ as the same value set as described. Through the compression fatigue test, 15 residual deformations εᵣ, and the corresponding number of fatigue load cycles n of these three samples (as shown in Table 1) are obtained respectively. Moreover, the fatigue life N_{f} of these three samples are measured.

The residual deformation of each sample and the corresponding fatigue life cycle are substituted into the following equation for fitting and solving, to get the parameters of the equation.

n=N_{f}(1−exp(−((εₚ−εₚ₀)/λₚ)^{k}^{ₚ}))

Wherein, the fitting values of position parameter εₚ₀, scale parameter λₚ, and shape parameter kₚ are shown in Table 1. The average value of λₚ/kₚ of samples 1, 2, and 3 is 0.04610.

TABLE 1
The compressive fatigue data of fiber-reinforced concrete
samples at for a stress level of 0.90

| | Residual | | Residual | | Residual |
|---|---|---|---|---|---|
| Number of | deformations | Number of | deformations | Number of | deformations |
| fatigue load | of | fatigue load | of | fatigue load | of |
| cycles of | sample 1, | cycles of | sample 2, | cycles of | sample 3, |
| sample 1, n | εₚ/% | sample 2, n | εₚ/% | sample 3, n | εₚ/% |
| 1 | 0.0701 | 1 | 0.0576 | 1 | 0.0839 |
| 11 | 0.0890 | 7 | 0.0783 | 19 | 0.1124 |
| 55 | 0.1069 | 35 | 0.0951 | 95 | 0.1493 |
| 110 | 0.1481 | 70 | 0.1089 | 190 | 0.1813 |
| 220 | 0.1460 | 140 | 0.1430 | 380 | 0.2080 |
| 330 | 0.1670 | 210 | 0.1496 | 570 | 0.2233 |
| 440 | 0.1730 | 280 | 0.1657 | 760 | 0.2249 |
| 550 | 0.1945 | 350 | 0.1901 | 950 | 0.2435 |
| 660 | 0.1978 | 420 | 0.1951 | 1140 | 0.2579 |
| 770 | 0.2067 | 490 | 0.2035 | 1330 | 0.2756 |
| 880 | 0.2005 | 560 | 0.2324 | 1520 | 0.2986 |
| 990 | 0.2154 | 630 | 0.2630 | 1710 | 0.3293 |
| 1045 | 0.2249 | 665 | 0.2674 | 1805 | 0.3309 |
| 1095 | 0.2634 | 697 | 0.2898 | 1891 | 0.3569 |
| 1099 | 0.2891 | 699 | 0.2895 | 1899 | 0.3674 |

| | | |
|---|---|---|
| N_{f1} = 1100 (measured) | N_{f2} = 700 (measured) | N_{f3} = 1900 (measured) |
| kₚ₁ = 6.58330 (fitting) | kₚ₂ = 3.23769 (fitting) | kₚ₃ = 3.34420 (fitting) |
| λₚ₁ = 0.19687 (fitting) | λₚ₂ = 0.17505 (fitting) | λₚ₃ = 0.18173 (fitting) |
| εₚ₀₁ = 0 (fitting) | εₚ₀₂ = 0 (fitting) | εₚ₀₃ = 0.08390 (fitting) |
| λₚ₁/kₚ₁ = 0.02990 | λₚ₂/kₚ₂ = 0.05407 | λₚ₃/kₚ₃ = 0.05434 |

Next, the prediction of the compressive fatigue life and characterization of the evolution law of fatigue deformation are performed for the three fiber-reinforced concrete samples at the stress levels of 0.85, 0.80 and 0.75, respectively.

(1) acquire 9 residual deformation εₚ and the number of fatigue load cycles n corresponding to each deformation of the fiber-reinforced concrete under a fatigue load at the stress levels of 0.85, 0.80 and 0.75, respectively (as shown in table 2);

(2) substitute these 9 residual deformations and the corresponding fatigue life cycle into the following equation for fitting and resolving, to obtain parameters of the equation:

n=N_{f}(1−exp(−((εₚ−εₚ₀)/λₚ)^{k}^{ₚ}))

It should be noted that in the fitting solution process, the value of λₚ/kₚ of the fiber-reinforced concrete is set at 0.04610.

The fitted values of the fatigue life N_{f}, position parameter εₚ₀, scale parameter λₚ, and shape parameter kₚ at various stress levels obtained by fitting and solving are shown in Table 2. The actual valves of fatigue life N_{f} at various stress levels are also shown in Table 2. It can be found that the predicted value obtained by the fitting is close to the actual value and the prediction accuracy is high. The obtained test data of each sample in Table 2 and the equation of fitting solution are shown in the sole FIGURE. Further, the subsequent fatigue data that is not obtained during the fitting solution is also plotted in the sole FIGURE. It can be found that there is a strong correlation between the fitting results and the prediction results based on the equation.

TABLE 2
The compressive fatigue data of fiber-reinforced concrete samples
at the stress levels of 0.85, 0.80 and 0.75

| | Residual | | Residual | | |
|---|---|---|---|---|---|
| Number of | deformations | Number of | deformations | Number of | Residual |
| fatigue load | of | fatigue load | of | fatigue load | deformations |
| cycles of | sample at | cycles of | sample at | cycles of | of sample |
| sample at | the stress | sample at | the stress | samples at | at the stress |
| stress level | level of | stress level | level of | stress level | level of |
| of 0.85, n | 0.85, εₚ/% | of 0.80, n | 0.80, εₚ/% | of 0.75, n | 0.75, εₚ/% |
| 1 | 0.0795 | 1 | 0.0544 | 1 | 0.0454 |
| 41 | 0.1412 | 359 | 0.1239 | 7183 | 0.1468 |
| 206 | 0.1933 | 1795 | 0.1484 | 35917 | 0.1791 |
| 412 | 0.2153 | 3591 | 0.1645 | 71834 | 0.1919 |
| 823 | 0.2342 | 7182 | 0.1739 | 143669 | 0.2151 |
| 1235 | 0.2447 | 10772 | 0.1879 | 215503 | 0.2297 |
| 1646 | 0.2583 | 14363 | 0.2003 | 287337 | 0.2378 |
| 2058 | 0.2765 | 17954 | 0.2169 | 359172 | 0.2557 |
| 2469 | 0.2841 | 21545 | 0.2345 | 431006 | 0.2715 |

| | | |
|---|---|---|
| k_{p-0.85} = 4.6242 (fitting) | k_{p-0.80} = 3.7850 (fitting) | k_{p-0.75} = 4.8627 (fitting) |
| λ_{p-0.85} = 0.2132 (fitting) | λ_{p-0.80} = 0.1745 (fitting) | λ_{p-0.75} = 0.2242 (fitting) |
| ε_{p0-0.85} = 0.0795 (fitting) | ε_{p0-0.80} = 0.0544 (fitting) | ε_{p0-0.75} = 0.0454 (fitting) |
| N_{f-0.85} = 4326 (fitting) | N_{f-0.80} = 32991 (fitting) | N_{f-0.75} = 682768 (fitting) |
| N_{f-0.85} = 4115 | N_{f-0.80} = 35908 | N_{f-0.75} = 718343 |
| (actual life) | (actual life) | (actual life) |

What is claimed is:

1. A fatigue life prediction method of concrete based on Weibull function and residual deformation, comprising the following steps:
(1) acquire several residual deformations εₚ and the number of fatigue load cycles n corresponding to each deformation of the concrete under a fatigue load at one certain stress level; the residual deformation εₚ refers to the deformation corresponding to the stress at zero;
(2) substitute the several residual deformation and corresponding fatigue load cycle into the following equation for fitting and solving, to obtain parameters of the equation:
n=N_{f}(1−exp(−((εₚ−εₚ₀)/λₚ)^{k}^{ₚ}))
wherein, N_{f} is fatigue life, εₚ₀ is position parameter, λₚ is scale parameter, kₚ is shape parameter;
The parameter N_{f} obtained in step (2) is the prediction of fatigue life, and the resulting equation is used to characterize the evolution law of fatigue deformation.

2. The fatigue life prediction method of concrete based on Weibull function and residual deformation according to claim 1, wherein an optional value for position parameter εₛ₀ is zero, and another optional value is the residual deformation of the concrete after the first cycle of the fatigue load.

3. The fatigue life prediction method of concrete based on Weibull function and residual deformation according to claim 1, wherein λₚ/kₚ is set to the same value for the same kind of concrete material.

4. A fatigue life prediction device of concrete based on Weibull function and residual deformation, comprising a data acquisition module, a parameter determination module and an information transmission module;
The data acquisition module is used to acquire several residual deformations εₚ and the number of fatigue load cycles n corresponding to each deformation of the concrete under a fatigue load at one certain stress level; the residual deformation εₚ refers to the deformation corresponding to the stress at zero;
The parameter determination module is used to substitute the several residual deformations and the corresponding fatigue life cycle into the following equation for fitting and solving, to obtain parameters of the equation:
n=N_{f}(1−exp(−((εₚ−εₚ₀)/λₚ)^{k}^{ₚ}))
wherein, N_{f} is fatigue life, εₚ₀ is position parameter, λₚ is scale parameter, kₚ is shape parameter;
The information transmission module is used to transmit parameters of the equation obtained by fitting and solving to a fixed receiver or a mobile receiver, wherein the parameter includes N_{f}.
